(19) United States
(12) Patent Application Publication
(10) Pub. No.: US 2010/0143826 A1
(43) Pub. Date: Jun. 10, 2010

(54) FIBROUS ANODE WITH HIGH SURFACE-TO-VOLUME RATIO FOR FUEL CELLS AND A FUEL CELL WITH SUCH ANODE

(75) Inventors: Pinchas Schechner, Kiryat Bialik (IL); Evgenia Bubis, Karmiel (IL); Ehud Kroll, Haifa (IL); Eyal Zussman, Haifa (IL); Shmuel Chervinski, Nesher (IL)

Correspondence Address: LOWE HAUPTMAN HAM & BERNER, LLP, 1700 DIAGONAL ROAD, SUITE 300, ALEXANDRIA, VA, 22314, US

(73) Assignees: OFEK ESHKOLOT RESEARCH AND DEVELOPMENT LTD, Karmiel (IL); TECHNION RESEARCH AND DEVELOPMENT FOUNDATION, Haifa (IL)

(21) Appl. No.: 12/522,710

(22) PCT Filed: Jan. 11, 2008
(86) PCT No.: PCT/IB08/00065

§ 371 Date: Jan. 19, 2010

Related U.S. Application Data
(60) Provisional application No. 60/884,714, filed on Jan. 12, 2007.

(51) Int. Cl. H01M 4/86; B05D 5/12

(52) U.S. Cl. 429/527; 429/523; 427/115

(57) ABSTRACT

A fuel cell anode with high surface-to-volume ratio made of fibrous mat is disclosed. The fuel cell anode can be a fibrous mat produced by electrospinning method. The disclosed anode enables to fuel with saccharides fuel cells. In a preferred embodiment the fuel cell anode is provided wherein the anode is an electrospun fibrous mat, wherein the fibers are made of a polymer coated by a conductive material, preferably silver. This anode can also be made of fibrous mat, wherein the fibers are made of polymer fibers that contain metallic particles. A fuel cell that contains the disclosed anode and a fuel, such as glucose, is also disclosed in the present invention.

### FIELD OF THE INVENTION

The present invention relates to the field of fuel cells. More specifically, the present invention relates to fuel cells with fuel solution and fibrous anode with high surface-to-volume ratio.

### BACKGROUND OF THE INVENTION

A fuel cell includes a cathode (oxidizer electrode) and an anode (fuel electrode), which face each other with an electrolyte (ion conductor) interposed between them and the anode is held in contact with fuel solution. The cathode is held in contact with an oxidizer. The fuel cell generates electric energy by the following mechanism. The anode is supplied with fuel, which is oxidized and decomposed into electrons and ions. The electrons move to the anode through a metallic electron conducting material. The ions move trough the electrolyte. The cathode is supplied with oxygen from the outside and electrons from the anode through the metallic electron conducting material.

The present invention provides a fuel cell that its anode (or both anode and cathode) is a fibrous membrane with high surface-to-volume ratio coated with catalytic conductive material e.g., silver. Such anode enables the use of fuel such as glucose or any other fuel. Moreover, the present invention provides a method for production of such anode and such fuel cell.

The present invention is particularly useful as fuel cell that is comprised of silver-plated electrospun fibrous anode and glucose solution as a fuel. In order to check the feasibility of such a composition an experimental work was done. This work will henceforth be described in detail with reference to FIGS. 1 to 3.

Glucose is an ideal renewable fuel. It has a high energy content: the volume enthalpy of combustion (ΔH_{c}⁰⁾_{V}—defined as the energy released when 1 cm³ of fuel is completely oxidized—is 24.3 kJ/cm³. Glucose has other advantages: it is non-explosive, abundant (glucose and its derivates represent more than 50% of the weight of the Flora), easy to extract, renewable, transportable, easy to store, non-flammable, non-poisonous, non-volatile, odorless, easy to produce anywhere and environmental friendly.

Fuel cells are electrochemical devices capable of converting chemical energy into electrical energy directly from fuels, with theoretical efficiencies higher than 0.8 at room temperature and with low pollutant emissions. Fuel cells that produce electricity from glucose and other saccharides could, in the future, replace batteries in portable devices, be used in electrical power plants consuming biomass waste, and serve as engines for transportation.

Glucose-fueled fuel cells are not commercially available yet. Two obstacles hinder the feasibility of this device. The first is the high stability of saccharides, which requires a good catalyst to produce the electricity from the fuel. The second is related to the nature of the fuel cells: the electrochemical process is a surface phenomenon. In order to obtain high power densities, structures with high surface-to-volume ratio are needed. Overcoming these two obstacles is the purpose of this invention.

Electrospinning is a method to produce fibers with a diameter in the range of a few micrometers to less than 100 nm. In this process, a polymer solution is supplied from a spinneret and forms a droplet at the spinneret exit. In the presence of an electrical field (˜1 kV/cm) applied to the solution and placing a counter-electrode (a collector) at some distance from the spinneret, the Maxwell electrical stress stretches the droplet, a Taylor cone is produced and jetting sets in. The jet exhibits an electrically-induced bending instability which causes the stretching of the bent sections of the jet. The solvent eventually evaporates, the jet dries and solidifies, and the as-spun fibers are deposited on the counter-electrode. A relatively large variability in the diameter of the fibers produced is inherent to electrospinning. The governing parameters in the electrospinning process were found to be related to the polymer solution rheology, conductivity, flow rate, electrical field and ambient humidity and temperature. The electrospun fibers form nonwoven mats with a large surface area per volume and very small pore size, which are of interest in a wide variety of applications such as filtration, membranes, reinforcing fibers in composite materials, biomedical devices and scaffolds for tissue engineering. The porosity and transport properties of the electrospun mats were found to be highly dependent on the fiber diameter. Alignment of the electrospun fibers and cross bar formation can be controlled by applying an electrostatic lens, using patterned collecting electrodes, or applying an AC field between two collecting electrodes.

Catalytic anodes were produced by electrospinning polycaprolactone into nonwoven fibrous mats. The polymer fibers were plated with silver by electroless deposition. The deposition of silver resulted in the catalytic capability to oxidize glucose and high conductivity. The electroplated mat was integrated as an anode in a membraneless AFC fueled with glucose. The dependence of the cell voltage on load resistance was measured.

The experimental method to obtain a conducting electrocatalytic nonwoven micrometric and sub-micrometric fibrous mats, capable of oxidizing glucose in an alkaline environment, is described below. The oxidation of glucose is assumed to be far from complete, with the product being gluconic acid. The anodic half reaction is:

2C₆H₁₂O₆+4OH⁻→4e⁻+2C₆H₁₂O₇+2H₂O [1]

and the reaction at the cathode is:

O₂+4e⁻+2H₂O→4OH⁻ [2]

The overall reaction is therefore:

2C₆H₁₂O₆+O₂→2C₆H₁₂O₇ [3]

The results were compared with those obtained for a control anode made of a flat foil of pure silver. The surface area of the fibrous membranes is estimated using simple mathematical relations among the physical properties of the mat. The experimental results obtained confirm the hypothesis that the current density is proportional to the estimated total surface area of the fibers in the anode.

Chemicals and solutions.—Six different solutions were prepared for the present work. The purpose of each solution, the chemicals involved in their preparation, their suppliers and the quantities used are listed in Table 1. All the materials are analytical grade and used as received without further treatment.

TABLE 1
Chemicals and solutions used in the present work.

| Solution | Purpose | Chemical (Supplier) | Quantities |
|---|---|---|---|
| A | Polymer fibers | Polycaprolactone (PCL), MW 80,000 g/mol. | 10% w/w in its |
| | | (Aldrich, USA) | solvent |
| | Solvents | Dimethylformamide (Frutarom, Israel) | 1 part by weight |
| | | Dichloromethane (BioLab, Israel) | 3 parts by weight |
| B | Plating | SnCl₂•2H₂O (Merck, Germany) | 114 g/l |
| | pretreatment | HCl (Frutarom, Israel) | 600 g/l |
| | | PdCl₂ (Fluka, Switzerland) | 2 g/l |
| | | Sodium Succinate (BDH, England) | 14 g/l |
| C | Silver plating | Silver nitrate (Carlo Ebra, Italy) | 3.5 g |
| | precursor - | Ammonia solution (Frutarom, Israel) | 40 ml. |
| | total 100 ml | Distilled water | 60 ml |
| | | Sodium hydroxide (Frutarom, Israel) | 2.5 g |
| D | Silver plating | Glucose anhydrous (Fluka, Switzerland) | 4.5 g |
| | precursor - | Tartaric acid (Merck, Germany) | 0.4 g |
| | total 100 ml | Ethanol (Carlo Ebra, Italy) | 10 ml |
| | | Distilled water | 90 ml |
| E* | Silver plating | Solution C | 1 part by volume |
| | | Solution D | 2 parts by volume |
| F | AFC fuel and | Glucose, anhydrous (Carlo Ebra, Italy) | 3.6 g |
| | electrolyte | 1 M in KOH (Frutarom, Israel) | 25 ml final volume |

*The solutions are mixed just before plating.

Membrane preparation.—Solution A was pumped into a syringe with a 25 gauge needle. An electrical field of about 1 KV/cm was applied between the solution and a horizontally rotating disk cathode collector by a high voltage transformer (Glassman Inc. High Voltage Power Supply). The rotating velocity of the cathode (10-cm radius) was 30 RPM. The needle was placed vertically downward with the tip about 15 cm above the cathode. The flow rate through the needle was 3 ml/h. Fibers for each mat were collected for about 1 hour of electrospinning, and then dried in vacuum for 24 hours. After the electrospinning process, the membranes passed a silver electroless plating process in two stages: (1) Activation pretreatment with stannous-palladium solution, and (2) Silver metallization. Both stages are summarized in Table 2.

TABLE 2
Pretreatment and silver metallization stages. See Table 1 for
description of the various solutions.

| Stage | Step | Step description |
|---|---|---|
| Pretreatment | 1 | Immersion of the PCL membrane in ethanol. |
| | 2 | Dipping the mat in distilled water. |
| | 3 | Immersion of the membrane in solution B (activation) for 5 minutes |
| | | at a temperature of 37 ± 2° C. |
| | 4 | Rinsing the activated mat with distilled water until the water becomes |
| | | clear. The membrane is kept in a distilled water bath until the next |
| | | stage. |
| Silver | 5 | Solutions C and D are heated to 37 ± 2° C. separately. |
| metallization | 6 | Solution E is prepared and maintained at 37 ± 2° C. |
| | 7 | The wet PCL membrane is immersed immediately in the heated E |
| | | solution for 5 minutes. The membrane acquires a light gray color. |
| | 8 | The membrane is washed with distilled water until the water becomes |
| | | clear. |
| | 9 | Drying of the membrane at room temperature on filter paper. |

The fuel cell.—Measurements were taken on an AFC fueled with glucose using KOH as the electrolyte (HKU-002C, Fuel Cell Research Lab., Dept. of Chemistry, Hong Kong University). The fuel is dissolved in the liquid alkaline electrolyte and both are placed together in the cell. The cell operates in a batch mode similar to a battery, where an initial finite quantity of fuel is added to it. The cathode (E-TEK, Somerset, N.J.) is impermeable and is part of one of the lateral walls, so that it is in contact with the ambient air. The cell has a rectangular base, 8-cm long by 6-cm wide, and its height is 11 cm.

Electrode characterization.—Two different membrane electrodes were prepared. One had fibers with a mean diameter d=3 μm (SC_{3μ}) and the other with d=0.76 μm (SC_{0.76μ}). For comparison, a control electrode of pure silver foil with a highly polished surface (PAg) was also prepared.

The diameter of the fibers was measured with a high resolution scanning electron microscope (HRSEM, LEO Gemini 982). Using the ImageJ image processing program, the micrographs of the fibers were sampled at 20 different fiber locations for each membrane and mean fiber diameter and standard deviation were calculated. The thickness of the membranes was measured with a digital micrometer by pressing the mat between two glass slides. The electrical resistance was tested by the four-point technique (Fluke 8840A multimeter).

Each membrane anode was cut to fit the dimensions of the fuel cell, clamped with screws between two brass bars, and immersed into the fuel-electrolyte solution of the cell. One side of the anodic membrane was in contact with the cell wall, thus only one side was exposed to the fuel-electrolyte solution. Table 3 summarizes the dimensions of the three electrodes studied in this work.

TABLE 3
Dimensions of the three electrodes.

| Electrode | Width (cm) | Height* (cm) | Area* (cm²) | Thickness (μm) |
|---|---|---|---|---|
| SC_{3μ} | 3.5 | 2.5 | 8.75 | ~200 |
| SC_{0.76μ} | 4.0 | 1.9 | 7.6 | ~200 |
| PAg | 4.5 | 2.5 | 11.25 | ~380 |

*Height and area are for the portion of the electrode immersed in solution F.

Experimental procedure.—Solution F was prepared promptly before introduction to the fuel cell chamber. The anode was immersed in the solution. All measurements were taken at room temperature. After a few minutes of equilibration, the OCV was recorded. The circuit was then closed with different external resistance loads, R_{L}. The behavior of the voltage was monitored as a function of time. The circuit was kept closed until the cell voltage reached a stable value, the disconnection voltage V_{d}, for at least one minute. The measurements were performed using cycles of “connect-disconnect” with different external R_{L} loads ranging from 1.5 to 1970 Ω.

This procedure was repeated with the fibrous membrane electrodes, and with the pure silver foil control anode. For the latter, the voltages obtained were much smaller, so a more sensitive voltmeter (Mastech M9803R multimeter) was used.

Mathematical relations that are used during the work are:

In order to plot the polarization curves, the fuel cell voltage at the instance of disconnection was measured, V_{d}, under different loads, R_{L}. The current density, J, was calculated from

J=V_{d}/(R_{L}Aₑ)(A/m²) [4]

where Aₑ is the physical area of the electrode (immersed height×width) in contact with solution F.

The values of V_{d} for each R_{L} were also used to determine the power density from the relation

P_{D}=JV_{d}=V_{d}²/(R_{L}Aₑ)(W/m²) [5]

The porosity of the mat, P, defined as the volume fraction of the pores relative to the whole mat, was calculated using the relation

P=1−(B_{f}/Bₚ) [6]

where B_{f} is the total volume of fibers, calculated by dividing the membrane's weight by the density of the fiber material, and Bₚ is the mat's physical volume calculated from its external dimensions.

It can be shown that the ratio of the estimated total fiber surface area to the electrode physical area, F_{f/e}, is:

F_{f/e}=4b(1−P)/d [7]

where b is the thickness of the electrode. By definition, the P_{Ag} control electrode has an F_{f/e} of one.

The results of this experimental work are described henceforth; FIGS. 1 and 2 are HRSEM images of the SC_{0.76μ} fibers in the mat. FIG. 1 shows the mat before the metallization process, while FIG. 2 shows it after metallization.

Table 4 summarizes the characterizing parameters of the silver-plated, electrospun PCL fiber anodes developed in this work along with the pure silver control anode. Table 4 also summarizes the data obtained when the cell was operated with the different electrodes. The OCV, the peak power density, PP_{D}, the current densities at which the PP_{D} was recorded, and the ratio of the PP_{D} of the membrane electrode to the PP_{D} of the control PAg anode, called F_{PPD}.

TABLE 4
Electrodes characterization and fuel cell performance

| Parameter (units) | SC_{3μ} | SC_{0.76μ} | PAg |
|---|---|---|---|
| Resistivity (Ωcm⁻¹) | <0.001 | <0.001 | <0.001 |
| Fiber Ag coverage (%) | ~100 | ~100 | NA |
| Fiber diameter*, d ± SD (μm) | 3 ± 1 | 0.76 ± 0.24 | NA |
| Porosity*, P (dimensionless) | 0.890 | 0.876 | NA |
| OCV (V) | 0.337 | 0.385 | 0.21 |
| PP_{D} (μW/cm²) | 43 | 196 | 1.43 |
| J@PP_{D} (mA/cm²) | 0.4 | 2.0 | 0.01 |
| F_{PPD} | 30.1 | 137.1 | 1 |

*Before metallization.

Effect of the anode's fiber surface area.—An increase in the total surface area of the fibers in an anode should produce an increase in the surface density of catalytic sites. More fuel molecules per unit area would be able to transfer their electrons to the anode, resulting in an increased current and power densities at a given cell voltage. This hypothesis is verified in Table 4, where the membrane with d=0.76 μm exhibits better electrical performance in all parameters than the membrane with d=3 μm.

The following is an effort to probe quantitatively the assumption that a decrease in the fiber diameter produces an increase in the current density. If this is correct, the ratio F_{f/e} (as given in Eq. 7) should be expected to correlate with F_{J}, the ratio of the current density of a membrane electrode, J_{SC}, to current density of foil electrode P_{Ag}, J_{PAg}, for a given voltage:

F_{J}=J_{SC}/J_{PAg} [8]

Using the data from Tables 3 and 4, the values for F_{f/e} for the fibrous membranes were computed using Eq. 7 for a range of fiber diameters defined as the mean±one standard deviation. The results are plotted in FIG. 3 as horizontal dashed lines that show lower and upper values of F_{f/e}, when the scatter in fiber diameter is taken into consideration. Current densities of each anodic membrane for 13 different cell voltages were extracted by interpolation of the data. The interpolated J_{SC} and the corresponding J_{PAg} points were used to calculate F_{J} using Eq. 10, and the results are plotted in FIG. 3.

FIG. 3 shows that the experimental current density ratios, F_{J}, at a given voltage are between the theoretical limits predicted by Eq. 9 for the ratio F_{f/e}. This validates our hypothesis that the electrical current is proportional to the total surface area of fibers.

There is a clear trend of decreasing F_{J} with increasing J. This behavior can be explained as follows: Eq. 9 predicts the ratio of the surface area of fibers to the physical area of the anode, assuming that the anode consists of long cylindrical fibers. However, the electrochemical reaction is not governed solely by the surface area of the catalyst in contact with the solution. The mobility of the reactant and product molecules also affects the electron transfer rate from the fuel molecules to the electrode. The influence of the molecules mobility is more significant at higher current densities.

This work has been performed with anodic membranes created by electroless silver plating of PCL fibers using the electrospining technology at room temperature and using glucose as a fuel.

Other methods related to this work can be considered:
Plating the fibers by other methods different then electroless plating, such as electroplating, sputtering, etc.
Plating the fibers with other metals, such as platinum, nickel, copper, etc.
The use of other polymers, besides PCL, for the structuring of the fibers, such as polypropylene, polyethylene, polypyrrole, etc.
Electroless plating of non-membranic plates.
The production of the fibers by other methods beside the electrospinning method.
Inclusion of metallic particles into the polymer fibers.
The use of higher temperatures than room temperature.
The use of other saccharides as fuels, beside glucose, such as fructose, lactose, etc.
The use of other organic substances as fuels, beside glucose, such as alcohols, hydrocarbons, organic acids, aldehydes, and other substances containing carbon-hydrogen links.
The use of similar membranes as cathodes, especially for the reduction of molecular oxygen.
The use of inorganic substances as fuels, such as hydrogen and borohydride.

It is concluded that a high surface-to volume ratio anode, capable to electro-oxidize glucose, has been developed. The electrode consists of a nonwoven mat of polymer fibers produced by electro spinning, followed by silver electroless plating. This technique of fabricating fuel cell electrodes is simple and economical, and was shown to facilitate “packing” of a large surface area in a relatively small physical volume. A correlation between the electrical current of the cell and the estimated total surface area of the fibrous membrane was established.

It was also found that the experimental current density ratio, F_{J}, decreases as the current density, J, increases. This fact was explained by the relatively low mobility of the glucose.

### SUMMARY OF THE INVENTION

The present invention provides a fibrous anode with high surface-to-volume ratio coated with conductive material, a fuel cell with such anode and a method for producing such anode. The present invention enables to produce fuel cells using stable fuel such as glucose or any other organic compound dissolved in water.

According to the teachings of the present invention there is provided a fuel cell comprised of (a) a cathode and an anode facing each other with (b) an electrolyte interposed therebetween, (c) fuel that is held in contact with at least part of the anode, wherein the anode is a fibrous mat anode—made of conductive fiber or non conductive fiber coated by conductive material—with high surface-to-volume ratio coated with conductive material and wherein at least part of the cathode is free to be in contact with air or oxygen.

According to a preferred embodiment the present invention is provided wherein at least one of the anode or cathode is an electrospun fibrous mat with high surface-to-volume ratio.

According to another preferred embodiment the present invention is provided wherein the fibrous mat anode is made of non conductive fibers that are coated by a conductive material.

According to another preferred embodiment the present invention is provided wherein the fibrous mat anode is made of polymer fibrous mat coated by silver and wherein the fuel is glucose.

According to another preferred embodiment the present invention is provided wherein the fibers, of the fibrous mat anode, are made of polymer that contains metallic particles.

According to yet another preferred embodiment the present invention is provided wherein the fibrous mat anode is made of polymer fibrous mat coated by platinum, nickel, copper or any other metal and wherein the fuel is fructose, lactose or any other saccharide. The polymer can be polycaprolactone, polypropylene, polyethylene, polypyrrole or any other polymer.

According to yet another preferred embodiment the present invention is provided wherein the fibrous mat anode is made of polymer fibrous mat coated by silver, platinum, nickel, copper or any other metal and wherein the fuel is alcohols, hydrocarbons, organic acids, aldehydes or any other organic fuel substances containing carbon-hydrogen links.

According to yet another preferred embodiment the present invention is provided, wherein the fuel is hydrogen, borohydride or any other inorganic fuel substances.

According to another aspect of the present invention, it is provided a fuel cell anode with high surface-to-volume ratio made of fibrous mat. The fuel cell anode can be a fibrous mat produced by electrospinning method.

According to a preferred embodiment the fuel cell anode is provided wherein the anode is a fibrous mat, wherein the fibers are made of a polymer coated by a conductive material. The anode can also be made of a fibrous mat, wherein the fibers are made of polymer fibers that contain metallic particles.

According to another preferred embodiment the fuel cell anode is provided wherein it is a fibrous mat anode and wherein the fibers are made of polymer coated by silver.

According to another preferred embodiment the fuel cell anode is provided wherein the anode is assembled together with a cathode face to face with an electrolyte interposed therebetween, ready for use with any fuel cell. This assembly is so called Membrane Electrolyte Assembly (MEA).

According to yet another aspect of the present invention, a method for producing fuel cell anode with high surface-to-volume ratio is provided. The method is comprised of the following steps:

(a) producing a fibrous mat from very small diameter fibers; and

(b) coating said mat's fibers by a conductive material.

The mentioned method is also provided wherein the fibrous mat's production is done by electrospinning method, having fibers with a diameter in the range of a few micrometers to less than 30 nm.

The mentioned method is also provided wherein, wherein the electrospinning process is used with a presence of high voltage electrical field between 0.4 kV/cm and 2.0 kV/cm.

The mentioned method is also provided wherein the fibrous mat is produced from any polymer and wherein the coating is done by silver.

According to another aspect of the present invention, it is provided an article of manufacturing comprising an electrospun element, that may serve as an anode or a cathode in a fuel cell, having a controllable porosity and permeability. This electrospun element can be manufactured by the way of: dispensing from a dispenser at least one liquefied polymer within an electrostatic field in a direction of a rotating collector so as to form at least one jet of polymer fibers.

According to a preferred embodiment the article of manufacturing is provided, wherein the average pore size has a maximal average pore diameter of about 200 μm and a minimal average pore diameter of about 0.1 μm.

According to another preferred embodiment the article of manufacturing is provided, wherein the polymer is biocompatible and at least one of the biocompatible polymers is selected from the group consisting of PCL, PLA, PGA, PAN, PMMA, Polyamide and Polyimide.

According to yet another aspect of the present invention it is provided a method of manufacturing an electrospun element, the method is comprised of: (a) dispensing from a dispenser at least one liquefied polymer within an electrostatic field in a direction of a rotating collector so as to form at least one jet of polymer fibers.

### BRIEF DESCRIPTION OF THE FIGURES

The invention is herein described, by way of example only, with reference to the accompanying drawings, FIGS. 4, 5, 6 and 7. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the figures:

FIGS. 1 to 3 are referring to the background section above. FIGS. 4, 5, 6 & 7 are illustrating preferred embodiments.

FIG. 4 illustrates a fuel cell embodiment of the present invention.

FIG. 5 illustrates a cross section of a fuel cell's preferred embodiment, helping the process explanation.

FIG. 6 illustrates an anode's structure according to the present invention.

FIG. 7 illustrates one sample of many ways of designing fuel cell of the present invention.

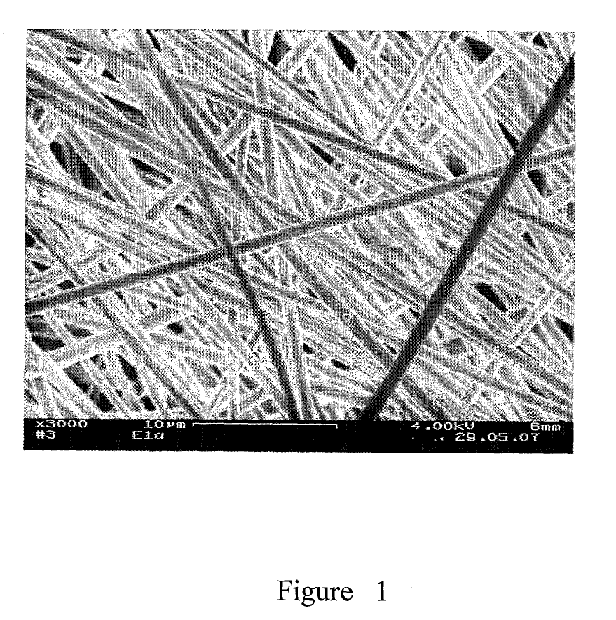

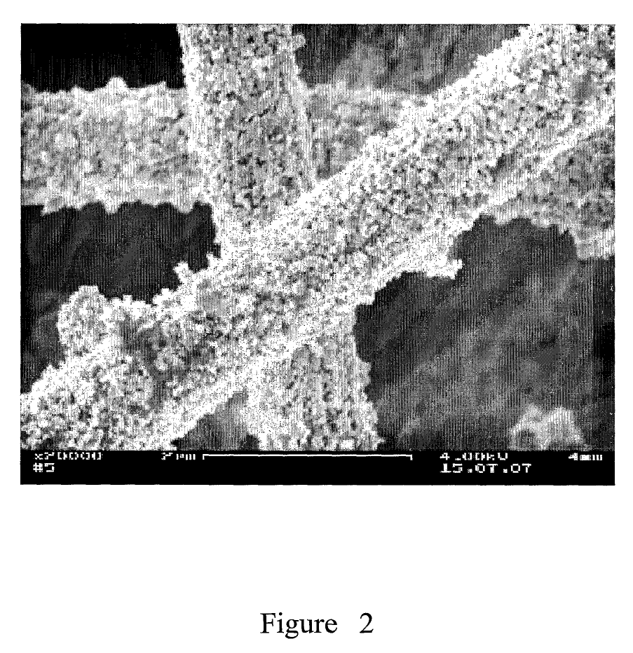

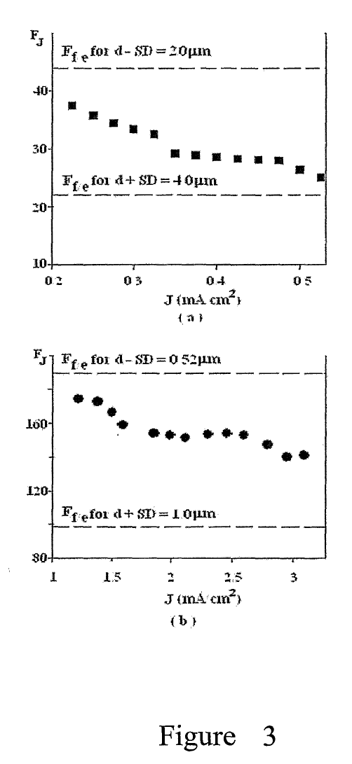

### DESCRIPTION OF THE PREFERRED EMBODIMENTS

The present invention is a fibrous polymer anode coated with conductive material, a method for producing such anode and a fuel cell that its anode—and optionally its cathode has the same structure—is the above mentioned anode.

The principles and operation of present invention may be better understood with reference to the drawings (4, 5, 6 and 7) and the accompanying description.

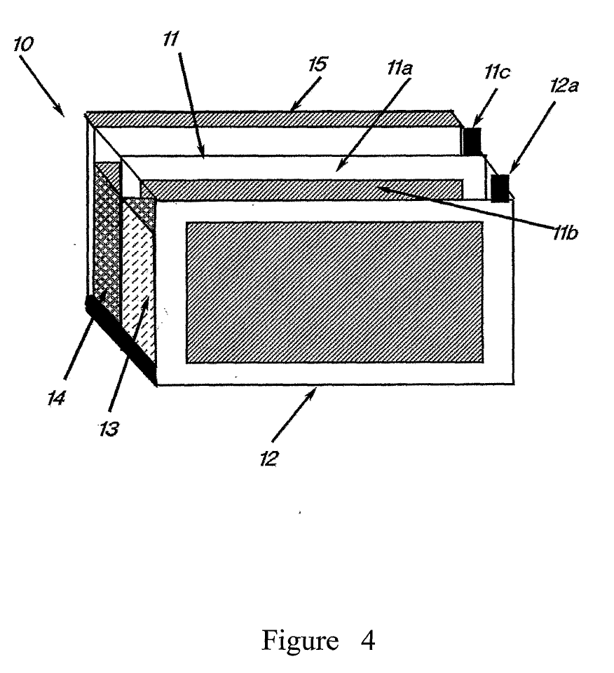

Referring now to the drawing, FIG. 4 illustrates a fuel cell embodiment of the present invention. The illustrated fuel cell 10 is built of an anode 11 and a cathode 12 facing each other with an electrolyte 13 interposed therebetween, the back of the anode is in contact with a glucose fuel solution 14 that is held by a housing 15. The back of the cathode 12 is open to the air. The anode 11 (and the cathode 12 as well) comprised of a conductive frame 11a in which a fibrous mat lib is framed. This fibrous mat 11b is an electrospun mat made of polymer fibers coated with silver. The electrical power appears in the output contacts of the anode 11c and the cathode 12a.

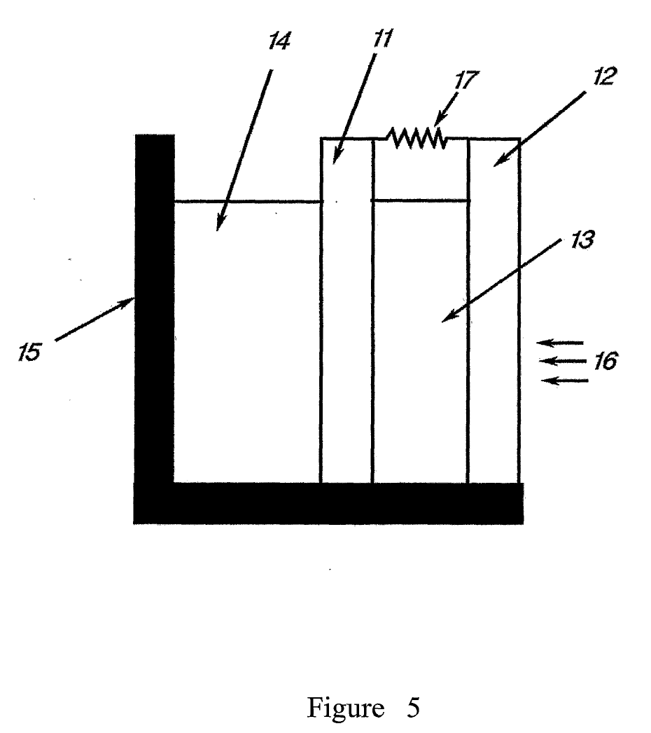

FIG. 5 illustrates a cross section of a fuel cell's preferred embodiment. The anode 11 and the cathode 12 are facing each other holding the electrolyte 13 interposed therebetween. The glucose fuel 14 is interposed between the back of the anode 11 and housing's wall 15.

The fuel cell 10 generates electric energy by the following mechanism. The anode 11 is supplied with fuel 14, which is oxidized and decomposed into electrons and ions. The electrons move to the anode 11 through a metallic electron conducting material. The cathode 12 is supplied with oxygen 16 from the outside and electrons from the anode 11 through an external circuit 17. The ions move trough the electrolyte 13.

Since the fuel 14 is a stable compound, sufficient surface with efficient catalyst are needed to receive valuable electrical power. In order to achieve these requirements the anode 11 (and optionally the cathode 12) is made of electrospun fibrous mat with high surface-to-volume ratio coated with silver.

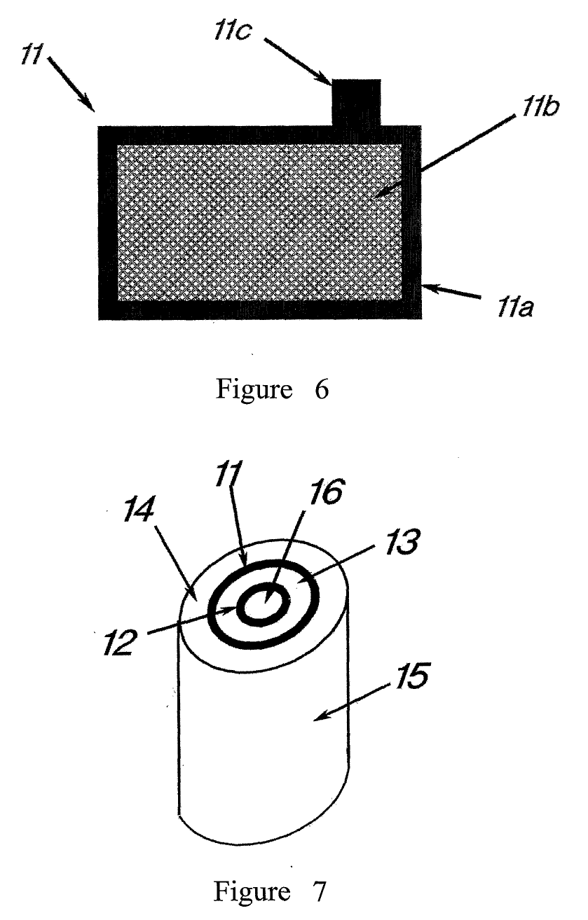

FIG. 6 illustrates anode's structure according to the present invention. A fibrous mat 11b—that is made of electrospun fibers coated with silver—is framed by a conductive frame 11a creating the anode 11 (or a cathode with the same structure). The anode 11 has a conductive contact 11c to connect the fuel cell to an electrical consumer.

FIG. 7 illustrates one sample of many ways of designing fuel cell. In the illustrated design the fuel cell is assembled as a cylinder shape. The illustrated design made of three cylinders, the inner cylinder is the cathode 12 and it is hollow enabling contact with air 16. The cathode 12 is surrounding by the electrolyte 13 that is delimitated by the middle cylinder 11, which is the anode. The glucose fuel 14 is located between the anode 11 and the housing 15, the outer cylinder.

As used herein in the specification and in the claims section that follows, the term “mat” and the like refers to a non-woven micrometric or nanometric fibrous membrane and the term “stable” material or solution refers to a material or solution that is chemically difficult to change.

As used herein the phrase “polymeric solution” refers to a soluble polymer, i.e., a liquid medium containing one or more polymers, co-polymers or blends of polymers dissolved in a solvent. The polymer used by the invention can be a natural, synthetic, biocompatible and/or biodegradable polymer.

The phrase “synthetic polymer” refers to polymers that are not found in nature, even if the polymers are made from naturally occurring biomaterials. Examples include, but are not limited to, aliphatic polyesters, poly(amino acids), copoly(ether-esters), polyalkylenes oxalates, polyamides, tyrosine derived polycarbonates, poly(iminocarbonates), polyorthoesters, polyoxaesters, polyamidoesters, polyoxaesters containing amine groups, poly(anhydrides), polyphosphazenes, and combinations thereof.

Suitable synthetic polymers for use by the invention can also include biosynthetic polymers based on sequences found in collagen, elastin, thrombin, fibronectin, starches, poly(amino acid), poly(propylene fumarate), gelatin, alginate, pectin, fibrin, oxidized cellulose, chitin, chitosan, tropoelastin, hyaluronic acid, polyethylene, polyethylene terephthalate, poly(tetrafluoroethylene), polycarbonate, polypropylene and poly(vinyl alcohol), ribonucleic acids, deoxyribonucleic acids, polypeptides, proteins, polysaccharides, polynucleotides and combinations thereof.

The phrase “natural polymer” refers to polymers that are naturally occurring. Non-limiting examples of such polymers include, silk, collagen-based materials, chitosan, hyaluronic acid, albumin, fibrinogen, and alginate.

As used herein, the phrase “co-polymer” refers to a polymer of at least two chemically distinct monomers. Non-limiting examples of co-polymers include, polylactic acid (PLA)-polyethyleneglycol (PEG), polyethylene glycol terephthalate (PEGT)/polybutylene terephthalate (PBT), PLA-polyglycolic acid (PGA), PEG-polycaprolactone (PCL) and PCL-PLA.

As used herein, the phrase “blends of polymers” refers to the result of mixing two or more polymers together to create a new material with different physical properties.

The phrase “biocompatible polymer” refers to any polymer (synthetic or natural) which when in contact with cells, tissues or body fluid of an organism does not induce adverse effects such as immunological reactions and/or rejections and the like. It will be appreciated that a biocompatible polymer can also be a biodegradable polymer.

According to an embodiment of the invention, the first and the second polymeric solutions are biocompatible.

Non-limiting examples of biocompatible polymers include Polyesters (PE), PCL, Calcium sulfate, PLA, PGA, PEG, polyvinyl alcohol, polyvinyl pyrrolidone, Polytetrafluoroethylene (PTFE, teflon), Polypropylene (PP), Polyvinylchloride (PVC), Polymethylmethacrylate (PMMA), Polyamides, segmented polyurethane, polycarbonate-urethane and thermoplastic polyether urethane, silicone-polyether-urethane, silicone-polycarbonate-urethane Collagen, PEG-DMA, Alginate, Hydroxyapatite and Chitosan, blends and copolymers thereof.

The phrase “biodegradable polymer” refers to a synthetic or natural polymer which can be degraded (i.e., broken down) in the physiological environment such as by proteases. Biodegradability depends on the availability of degradation substrates (i.e., biological materials or portion thereof which are part of the polymer), the presence of biodegrading materials (e.g., microorganisms, enzymes, proteins) and the availability of oxygen (for aerobic organisms, microorganisms or portions thereof), carbon dioxide (for anaerobic organisms, microorganisms or portions thereof) and/or other nutrients. Examples of biodegradable polymers/materials include, but are not limited to, collagen (e.g., Collagen I or IV), fibrin, hyaluronic acid, polylactic acid (PLA), polyglycolic acid (PGA), polycaprolactone (PCL), polydioxanone (PDO), trimethylene carbonate (TMC), polyethyleneglycol (PEG), Collagen, PEG-DMA, Alginate, chitosan copolymers or mixtures thereof.

According to an embodiment, the polymeric solution can be made of one polymer or more, each can be a polymer or a co-polymer such as described hereinabove.

According to an embodiment of the invention, the polymeric solution of the invention is a mixture of at least one biocompatible polymer and a co-polymer (either biodegradable or non-biodegradable).

According to an embodiment of the invention, the first polymeric solution for forming the shell can be made of a polymer such as poly(e-caprolactone) (PCL), polyamide, poly(siloxane), poly(silicone), poly(ethylene), poly(vinyl pyrrolidone), poly(2-hydroxy ethylmethacrylate), poly(N-vinyl pyrrolidone), poly(methyl methacrylate), poly(vinyl alcohol), poly(acrylic acid), poly(vinyl acetate), polyacrylamide, poly(ethylene-co-vinyl acetate), poly(ethylene glycol), poly(methacrylic acid), polylactide, polyglycolide, poly(lactide-coglycolide), polyanhydride, polyorthoester, poly(carbonate), poly(acrylo nitrile), poly(ethylene oxide), polyaniline, polyvinyl carbazole, polystyrene, poly(vinyl phenol), polyhydroxyacid, poly(caprolactone), polyanhydride, polyhydroxyalkanoate, polyurethane, collagen, albumin, alginate, chitosan, starch, hyaluronic acid, and blends and copolymers thereof.

According to an embodiment of the invention, the second polymeric solution for forming the coat over the internal surface of the shell can be made of a polymer such as poly(acrylic acid), poly(vinyl acetate), polyacrylamide, poly(ethylene-co-vinyl acetate), poly(ethylene glycol), poly(methacrylic acid), polylactide polyglycolide, poly(lactide-coglycolide), polyanhydride, polyorthoester, poly(carbonate), poly(ethylene oxide), polyaniline, polyvinyl carbazole, polystyrene, poly(vinyl phenol), polyhydroxyacid, alginate, starch, hyaluronic acid, and blends and copolymers thereof.

Although the invention has been described in conjunction with specific embodiments thereof, it is evident that many alternatives, modifications and variations will be apparent to those skilled in the art, accordingly, it is intended to embrace all such alternatives, modifications and variations that fall within the spirit and broad scope of the appended claims.

What is claimed is:

1. A fuel cell comprising: a cathode and an anode facing each other with an electrolyte interposed therebetween, fuel that is held in contact with at least part of said anode, wherein said anode is a fibrous mat anode—made of conductive fiber or non conductive fiber coated by conductive material—with high surface-to-volume ratio and at least part of said cathode is free to be in contact with air or oxygen.

2. The fuel cell of claim 1, wherein at least one of said anode or said cathode is an electrospun fibrous mat with high surface-to-volume ratio.

3. The fuel cell of claim 1, wherein said fuel is an organic compound dissolved in water or any other solvent.

4. The fuel cell of claim 1, wherein said fibrous mat anode is made of non conductive fibers that are coated by a conductive material.

5. The fuel cell of claim 1, wherein said fibrous mat anode is made of polymer fibrous mat coated by silver and wherein said fuel is glucose.

6. The fuel cell of claim 1, wherein the fibers, of said fibrous mat anode, are made of polymer that contains metallic particles.

7. The fuel cell of claim 1, wherein said fibrous mat anode is made of polymer fibrous mat coated by platinum, nickel, copper or any other metal and wherein said fuel is fructose, lactose or any other saccharide.

8. The fuel cell of claim 7, wherein said polymer is polycaprolactone, PAN, PMMA, polypropylene, polyethylene, polypyrrole or any other polymer.

9. The fuel cell of claim 1, wherein said fibrous mat anode is made of polymer fibrous mat coated by silver, platinum, nickel, copper, any other metal or a combination of said metals and wherein said fuel is alcohols, hydrocarbons, organic acids, aldehydes or any other organic fuel substance containing carbon-hydrogen links.

10. The fuel cell of claim 9, wherein said fuel is hydrogen, borohydride or any other inorganic fuel substance.

11. A fuel cell anode with high surface-to-volume ratio made of fibrous mat.

12. The fuel cell anode of claim 11, wherein said anode is a fibrous mat produced by electrospinning method.

13. The fuel cell anode of claim 11, wherein said anode is a fibrous mat, wherein the fibers are made of a polymer coated by a conductive material.

14. The fuel cell anode of claim 11, wherein said anode is a fibrous mat, wherein the fibers are made of polymer fibers that contain metallic particles.

15. The fuel cell anode of claim 11, wherein said anode is a fibrous mat and wherein the fibers are made of polymer coated by silver.

16. The fuel cell anode of claim 11, wherein said anode is assembled together with a cathode face to face with an electrolyte interposed therebetween, ready for use with any fuel cell.

17. A method of producing fuel cell anode with high surface-to-volume ratio, said method comprising:
producing a fibrous mat from very small diameter fibers; and
coating said membrane's fibers by a conductive material.

18. The method of claim 17, wherein said fibrous mat's production is done by electrospinning method, having fibers with a diameter in the range of a few micrometers to less than 30 nm.

19. The method of claim 18, wherein said electrospinning process is used with a presence of high voltage electrical field between 0.4 kV/cm and 2.0 kV/cm.

20. An article of manufacturing comprising an electrospun element having a controllable porosity and permeability for the purpose to serve as an anode or a cathode in a fuel cell.

21. The article of manufacturing of claim 20, wherein said electrospun element is manufactured by the way of dispensing from a dispenser at least one liquefied polymer within an electrostatic field in a direction of a rotating collector so as to form at least one jet of polymer fibers.

22. The article of manufacturing of claims 21, wherein said average pore size has a maximal average pore diameter of about 200 μm and a minimal average pore diameter of about 0.1 μm.

23. A method of manufacturing an electrospun element, the method comprising dispensing from a dispenser at least one liquefied polymer within an electrostatic field in a direction of a rotating collector so as to form at least one jet of polymer fibers for the purpose to serve as an anode or a cathode in a fuel cell.

24. The method of claim 23, wherein said polymer is biocompatible and at least one of said biocompatible polymer is selected from the group consisting of PCL, PLA, PGA, PAN, PMMA, and Polyamide.
